(19) United States
(12) Patent Application Publication
(10) Pub. No.: US 2014/0067805 A1
(43) Pub. Date: Mar. 6, 2014

(54) Cloud-based information exchange using identifiers such as QR codes

(71) Applicant: Michael J. Ure, Cupertino, CA (US)

(72) Inventor: Michael J. Ure, Cupertino, CA (US)

(21) Appl. No.: 14/012,375

(22) Filed: Aug. 28, 2013

Related U.S. Application Data
(60) Provisional application No. 61/693,869, filed on Aug. 28, 2012.

(51) Int. Cl. G06F 17/30

(52) U.S. Cl. CPC G06F 17/30011
USPC 707/736

(57) ABSTRACT

Document capture and tracking is simplified using coded information that may be printed on the document. In one embodiment, the coded information is scanned. As a result, the information of the document or a pointer thereto is retrieved or stored from a server (i.e., from the cloud). Preferably, the information of the document is in XML format such that one or more interested programs may process the information intelligently.

### BACKGROUND

The present invention relates to document storage and retrieval.

Paper documents, if they are in fact important, are also cumbersome in that information capture and tracking is often a manual process. Attempts have been made to automate the capture and tracking of information contained in paper documents. Those efforts have had mixed success.

### BRIEF DESCRIPTION OF THE DRAWING FIGURES

The present invention may be understood from the following description in conjunction with the appended drawing figures. In the drawing:

FIG. 1 is a block diagram of a document capture and tracking system.

### DETAILED DESCRIPTION

### Summary

Document capture and tracking is simplified using coded information that may be printed on the document. In one embodiment, the coded information is scanned. As a result, the information of the document or a pointer thereto is retrieved or stored from a server (i.e., from the cloud). Preferably, the information of the document is in XML format such that one or more interested programs may process the information intelligently.

In one embodiment, a method of cloud-based information exchange is provided in which a document is generated that includes identifying information. The document is stored on one or more servers in a format that is both human-readable and machine-readable. The identifying information is scanned using, for example, a mobile electronic device. In response to the scanning, at least one of the following is performed: retrieving and displaying the document; storing a copy of the document; storing a pointer to the document; and extracting information from the document and storing the extracted information.

The identifier may be any of various types of identifiers. One example is a QR code. Another example is an identifier, visible or not visible, printed using capacitive ink so as to be scanning using the touchscreen of a mobile electronic device.

### Description

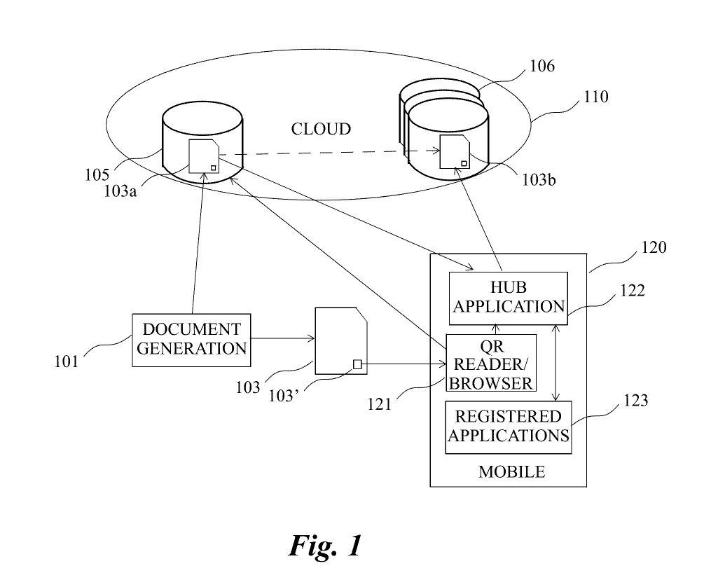

Referring now to FIG. 1, a block diagram is shown of a system for cloud-based information exchange using identifiers such as QR codes.

A document generation step 101 results in a document 103 including a identifier 103′ that is provided to a user and is stored on one or more servers 105 in the cloud 110, meaning that the document is readily accessible to devices including, for example, mobile electronic devices.

In the illustrated example, a mobile electronic device 120 is provided with QR reader and browser functionality 121, with a hub application 122, and with one or more registered applications 123. Block 121 enables the mobile electronic device 120 to communicate with the cloud 110. The hub application 122 also communicates with the cloud, either directly or through block 121.

The following paragraphs describe typical operation of the system of FIG. 1.

1. Document generation occurs, resulting in a printed or electronic document 103 bearing an identifier 103′ such as a QR code. A form of the document 103a is stored in the cloud 110. Examples of documents include sales receipts (Smart Receipts), invoices (Smart Invoices), warranties, manuals, instruments, policies, etc. The document may be in XML format or other such formats.

2. Identifier 103′ such as a QR code is scanned using a mobile device 120 or other intelligent device. The identifier 103′ identifies, directly, or indirectly, where the document 103a is stored in the cloud 110. This location is accessed through the browser functionality of the block 121.

3. In response to scanning, a hub application 122 is latched and the document 103a, or a description of the document 103a, is retrieved by the hub application 122, e.g., through the browser functionality of block 121. Both the hub application 122 and the document location may be identified by the identifier. For example, an Android phone can be configured to run an arbitrary app when a user clicks on a link of a certain type or scans the QR code equivalent. (The app is assumed to have been installed prior to the user clicking or scanning.) The hub application then “consumes” a web page that contains the document 103a, with the identifier telling the hub application where the enclosing web page can be found. Various other mechanisms other than the mechanism described may doubtless be used to achieve the same overall operation.

4. The hub application 122 notifies registered applications 123 and makes the document 103a or description of the document 103a available to the registered applications 123. Examples of registered applications 123 include Quicken™ software, other financial apps, contract management apps, etc.

5. The document 103a or data from the document 103a is stored in the cloud 110 on one or more servers 106 as document 103b, accessible to the interested applications among the registered applications 123. The document 103a may be retrieved from the cloud and re-stored, or the server 105 storing the document 103a may store a copy of the document 103a in the cloud 110 at the instruction of the host application 122.

6. In some instances, the hub application 122 may perform the function of the registered applications 123. The same document, or information therefrom, may be stored in multiple places.

7. The document 103a or document information, instead of being stored in the cloud 110 for access by the applications 123, may be stored locally, may be synched with other devices, etc. Also, instead of storing the document 103a again, one or more pointers or links to the original document instance 103a may be stored.

It will be appreciated by those skilled in the art that the present invention may be embodied in other specific forms without departing from the spirit or essential character thereof. The foregoing description is therefore intended in all respects to be illustrative and not restrictive. The scope of the invention is indicated by the appended claims, not the foregoing description, and all changes that come within the meaning and range of equivalents thereof are intended to be embraced therein.

What is claimed is:

1. A method of cloud-based information exchange, comprising:
generating a document comprising identifying information;
storing the document on one or more servers in a format that is both human-readable and machine-readable;
scanning the identifying information using a mobile electronic device; and
in response to the scanning, at least one of:
retrieving and displaying the document;
storing a copy of the document;
storing a pointer to the document; and
extracting information from the document and storing the extracted information.
